(19) United States
(12) Patent Application Publication
(10) Pub. No.: US 2018/0040212 A1
(43) Pub. Date: Feb. 8, 2018

(54) THREAT WARNING SYSTEM ADAPTED TO A VIRTUAL REALITY DISPLAY SYSTEM AND METHOD THEREOF

(71) Applicant: ARIMA COMMUNICATIONS CORP., TAIPEI CITY (TW)

(72) Inventors: JENG-CHIEH CHENG, NEW TAIPEI CITY (TW); CHING-I WANG, NEW TAIPEI CITY (TW); HSUEH-HSIN LU, TAOYUAN CITY (TW)

(21) Appl. No.: 15/785,488

(22) Filed: Oct. 17, 2017

Related U.S. Application Data
(63) Continuation-in-part of application No. 15/198,374, filed on Jun. 30, 2016.

(30) Foreign Application Priority Data
May 18, 2016 (TW) 105115357

(51) Int. Cl. G08B 7/06; H04N 13/04; G08B 13/184

(52) U.S. Cl. CPC G08B 7/06; G08B 13/184; H04N 13/044; H04N 2213/001; G01S 17/42

(57) ABSTRACT

A threat warning system adapted to a virtual reality display device is provided, which includes a detecting module which has a LIDAR, for sensing distance and direction of at least one external object; a tri-axils stabilizer for stabilizing the light scanning device; a warning module for producing a warning signal to alert the user of a direction of an external object; a control module electrically connected to the detecting module and the warning module; and the control module determining a distance of the external object based on the distance information. When a distance between the external object and the user has been determined smaller than the warning distance, the warning module sends a threat warning signal to the user. A threat warning method adapted to a virtual reality display device is also provided.

### CROSS-REFERENCE TO RELATED APPLICATION

This U.S. Non-provisional Application for Patent is a continuation-in-part (CIP) application of patent application Ser. No. 15/198,374 filed on Jun. 30, 2016. The entirety of the above-mentioned patent applications is hereby incorporated by reference herein and made as a part of this specification.

### BACKGROUND

### 1. Technical Field

The subject matter of the present disclosure is directed to a threat warning system and a method thereof and, in particular, to a threat warning system adapted to a head-mounted virtual reality display device and a method thereof

### 2. Description of Related Art

In the virtual reality display technology, the Head-Mounted Display (hereinafter referred to as HMD) is usually used as a display device to display three-dimensional images. The HMD applied to the virtual reality display technology is normally disposed with goggles which are used to entirely shade user's eyes to cover his/her sight. Two image display elements are disposed inside the goggles, and respectively correspond to user's eyes to produce image signals. Because the images signals produced by the image display elements have parallax, the three-dimensional visual effect is produced.

Existing virtual reality HMDs can be immersive or non-immersive. For the sake of immersing user in the visual effect of virtual reality produced by the HMD, it has to use the goggles to cover user's sight to prevent user from the surrounding image viewing, so that user can be immersed in the visual effect of virtual reality entirely.

When wearing the current HMD, the user cannot view his/her surroundings because their eyes have been covered by goggles, that is, the user is unable to perceive ambient potential threats. For example, user may get hit accidentally by external objects such as wall, desk, chair, electrical appliance, and so on when having exaggerated body movements.

In addition, when the user wears the HMD in public places such as on a flight or a long-distance coach, it is impossible to perceive ambient potential threats. If a thief or an invader approaches to user intentionally, it is impossible to avoid the user's belongings being taken away or to avoid user being attacked.

In view of this, the conventional head-mounted virtual reality display device has shortcomings. There is a need to improve its structure so as to ensure the safety and promote the utility for the user.

### SUMMARY

It is impossible to view the surroundings when wearing a conventional head-mounted virtual reality display device in order to perceive ambient potential threats because the user's eyes are covered by goggles. As a result, the primary object of the present disclosure is to provide a threat warning system adapted to a head-mounted virtual reality display device and a method thereof which aims to overcome the technical problem mentioned above.

According to one exemplary embodiment of the present disclosure, a threat warning system adapted to a virtual reality display device is provided, which includes: a head-mounted display device wearable on a user's head; a detecting module disposed with at least one sensor, the at least one sensor disposed on the head-mounted display device and sensing a distance between at least one external object and the user and a direction of the external object, and providing distance and direction information; a warning module producing a threat warning signal, and the user perceiving the distance of external object and the direction of external object relative to the user through the threat warning signal; and a control module electrically connected to the detecting module and the warning module, and determining whether a distance between the external object and the user is smaller than a warning distance based on the distance and direction information provided by the detecting module; and when the distance between the external object and the user has been determined smaller than the warning distance, the control module controlling the warning module to send the threat warning signal.

One of the embodiments of the threat warning module comprises a plurality of vibration units which are respectively disposed on the head-mounted display device at different angles, and the control module controls one or more vibration units which correspond to the direction of the external object to produce vibrations so as to produce the warning signal which corresponds to the direction of external object.

One of the embodiments of the threat warning signal comprises an audio signal, the warning module further comprises at least one audio unit, and the audio signal is produced by the at least one audio unit.

One of the embodiments of the threat warning signal further comprises a visual signal, and the control module drives the head-mounted display device to display the visual signal.

One of the embodiments of the threat warning system adapted to a virtual reality display device further comprises an image capturing module disposed with at least one image capturing lens, the image capturing module captures the user's surroundings, and the control module determines whether a distance of an external object is smaller than a warning distance; when the distance of an external object has been determined smaller than the warning distance, the control module switches an image source of the head-mounted display device to the surrounding image captured by the image capturing module, and then the head-mounted display device is driven to display the surroundings.

One of the embodiments of the threat warning system adapted to a virtual reality display device further comprises a signaling unit and a receiving unit, wherein the signaling unit is fastened on the user's belongings and sends a positioning signal, the receiving unit is electrically connected to the control module and receives the positioning signal to determine a distance between the signaling unit and the receiving unit; and when the distance between the signaling unit and the receiving unit has been determined to exceed a predetermined distance, the control module controls the warning module to send a warning signal.

According to another exemplary embodiment of the present disclosure, a threat warning method adapted to a virtual reality display device is provided, which includes the following steps: providing a detecting module and a warning module on a head-mounted display device, and the detecting module and the warning module electrically connected to a control module; detecting distance and direction of at least one external object by the control module, and outputting distance and direction information to the control module; and detecting distance and direction of at least one external object by the control module, and outputting distance and direction information to the control module; wherein the threat warning signal is a direction indicator for directing user to the direction of the external object.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a threat warning system adapted to a virtual reality display device of the present disclosure.

FIG. 2 is a perspective view of a threat warning system adapted to a virtual reality display device in one embodiment of the present disclosure.

FIG. 3 is the top view of a threat warning system adapted to a virtual reality display device in one embodiment of the present disclosure.

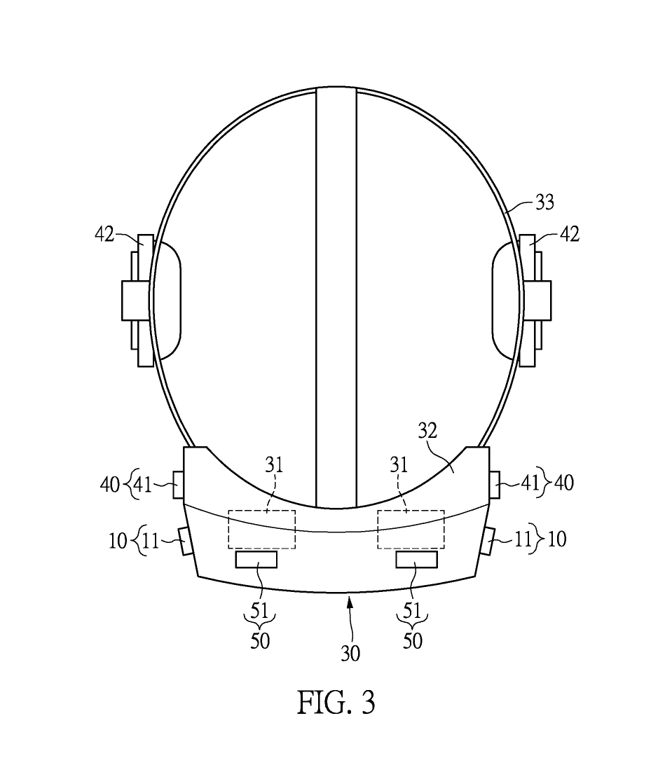

FIG. 4 is a schematic diagram illustrating how a threat warning system adapted to a virtual reality display device in one embodiment of present disclosure being operated.

FIG. 5 is a flow chart of a threat warning method adapted to a virtual reality display device of the present disclosure.

FIG. 6 is a perspective view of a threat warning system adapted to a virtual reality display device in another embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

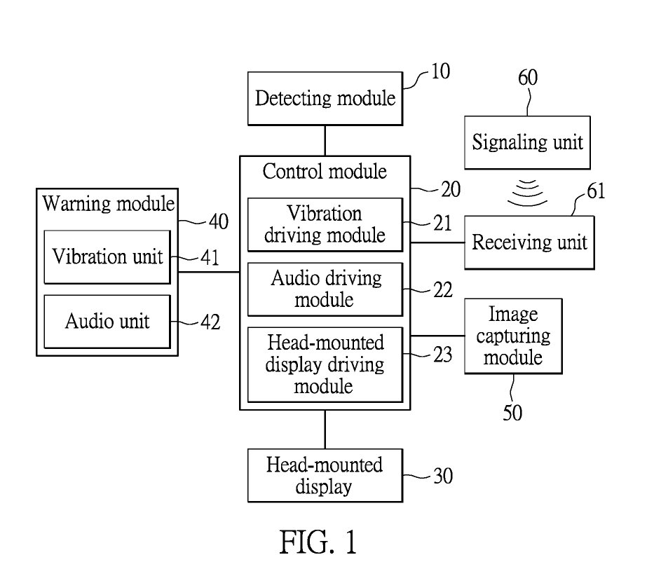

FIG. 1 is a block diagram of a threat warning system adapted to a virtual reality display device of the present disclosure. As shown in FIG. 1, the threat warning system adapted to a virtual reality display device of the present disclosure includes a detecting module 10, a control module 20, a head-mounted display device 30, a warning module 40 and an image capturing module 50.

The head-mounted display device 30 is a display device for displaying 3D images, and is disposed with goggles 32 and a headband 33. The goggles 32 are wearable on the user's head to cover his/her eyes. Two image display elements 31 are disposed inside the goggles 32, and respectively correspond to the user's eyes to display 3D images. This has a 3D visual effect on the user because the 3D images provided by the image display elements 31 have parallax.

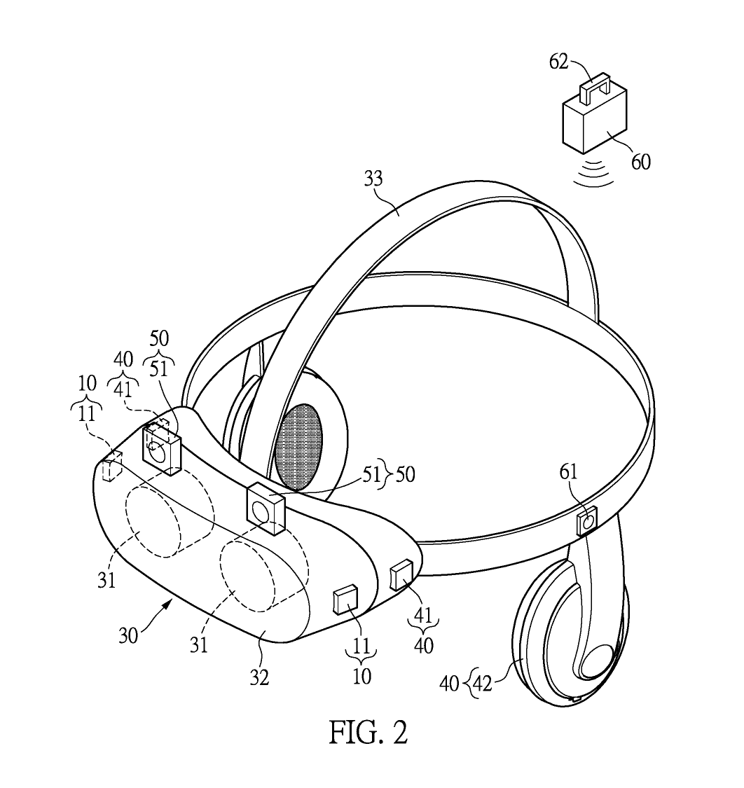

As shown in FIG. 1 and FIG. 2, the detecting module 10 is disposed with a plurality of sensors 11 which are respectively disposed on the goggles 32 of the head-mounted display device 30 at different angles. In the selected embodiment, the sensor 11 may be various distance sensors such as an acoustic wave sensor, an ultrasonic sensor, a laser rangefinder, a photoelectric sensor, a radio frequency device, and so forth. Because the plurality of sensors 11 are disposed on the goggles 32 of the head-mounted display device 30 at different angles, external objects in different directions and angles can be detected by the plurality of sensors 11. When an external object has been detected, distance and direction information are produced and transmitted to the control module 20.

As shown in FIG. 1, the control module 20 is electrically connected to the detecting module 10 and the warning module 40. The control module 20 determines whether a distance between an external object and user is smaller than a warning distance based on the distance and direction information provided by the detecting module 10. When the distance between the external object and user has been determined to be smaller than the warning distance, the control module 20 further controls the warning module 40 to produce a threat warning signal.

As shown in FIG. 1 and FIG. 2, the warning module 40 is disposed with a plurality of vibration units 41 and at least one audio unit 42 therein. In the selected embodiment, the control module 20 is disposed with a vibration driving module 21 for controlling the vibration units 41, an audio driving module 22 for controlling the audio unit 42 and a head-mounted display driving module 23 for driving the head-mounted display device 30. In the selected embodiment, the vibration unit 41 may be a vibration element, and each vibration unit 41 is disposed on the head-mounted display device 30 at different angles. The audio unit 42 may be a headset. It is unnecessary to add another audio unit, because the audio system of the virtual reality display system can be used as the audio unit 42.

The warning module 40 is controlled by the control module 20 to produce the threat warning signal. In the selected embodiment, the threat warning signal produced by the warning module 40 is also a direction indicator, thereby helping a user to identify the direction of the potential threat object.

The threat warning produced by the warning module 40 can be performed in the form of vibration, sound and/or visual display. In the selected embodiment, the threat warning produced by the warning module 40 includes a vibration signal. When the control module 20 has determined that the distance of an external object is smaller than the warning distance, the control module 20 controls a vibration driving module 21 to drive the vibration units 40 to produce vibrations based on the received vibration signal. In addition, the control module 20 further determines a direction of the external object based on the direction information, and then controls one or more the vibration units 40 which correspond to the direction of the external object to produce vibrations so as to produce a vibration signal which corresponds to the direction of the external object, so that the user can identify the direction of the external object according to the vibration signal produced by the vibration unit 41.

In the selected embodiment, the threat warning signal further includes an audio signal which can be a warning sound output by the audio unit 42. The audio signal can also be a direction indicator using sound, so that the user can identify the direction of the external object according to the warning sound which corresponds to the direction of the external object or depending on the sound levels produced by the audio unit 42.

In addition, the threat warning signal includes a visual signal which can be an image, a flashing light, and so on. The visual signal is displayed by the head-mounted display device 30, and is also a direction indicator, thereby helping the user to identify the direction of the external object.

When a threat has been confirmed, the threat warning system of the present disclosure can switch the image displayed by the head-mounted display device 30 to the surroundings captured by the image capturing module 50. As shown in FIG. 1 and FIG. 2, the image capturing module 50 is disposed with at least one image capturing lens 51 which is used to capture the user's surroundings. The surrounding image captured by the image capturing lens 51 is output to the head-mounted display device 30 through the head-mounted display driving module 23 of the control module 20, and then is displayed by the image display element 31 of the head-mounted display device 30, thereby allowing the user to view the external surroundings.

When the control module 20 has determined that a distance between an external object and the user is smaller than the warning distance, the image signal displayed by the head-mounted display device 30 is switched to the surroundings captured by the image capturing module 50, so that the user can view the external surroundings to take appropriate measures against the ambient potential threat.

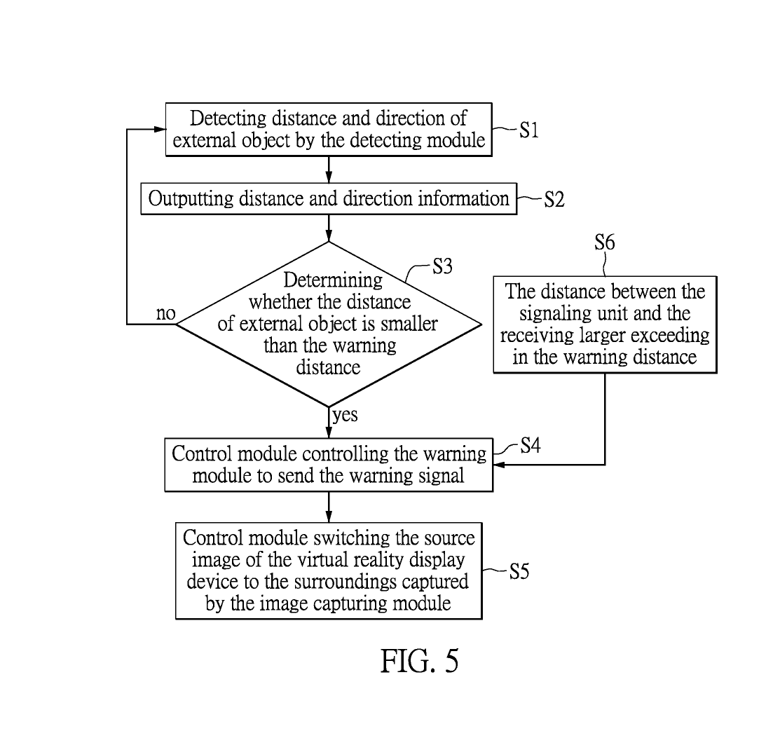

FIG. 5 is a flow chart of a threat warning method adapted to a virtual reality display device of the present disclosure. When the user wears the head-mounted display device 30 to play games or watch virtual reality video, the plurality of sensors 11 of the detecting module 10 continuously detect a relative distance between one or more external objects 70 and the user. The control module 20 keeps receiving the distance information produced by each sensor 11 to determine whether there are potential threats occurring at a relative distance between the external object 70 and user. When the distance between the external object 70 and the user has been determined to exceed a predetermined warning distance A, the control module 20 controls the warning module 40 to produce the threat warning signal to alert the user that he/she may get hit by the external object 70, and the direction the external object 70 where the ambient potential threats may occur from. In addition, the head-mounted display driving module 23 switches the image signal received by the head-mounted display device 30 to the surrounding image signal captured by the image capturing module 50, thereby allowing the user to perceive the potential threat through viewing the external surroundings so as to take appropriate measures against the threat.

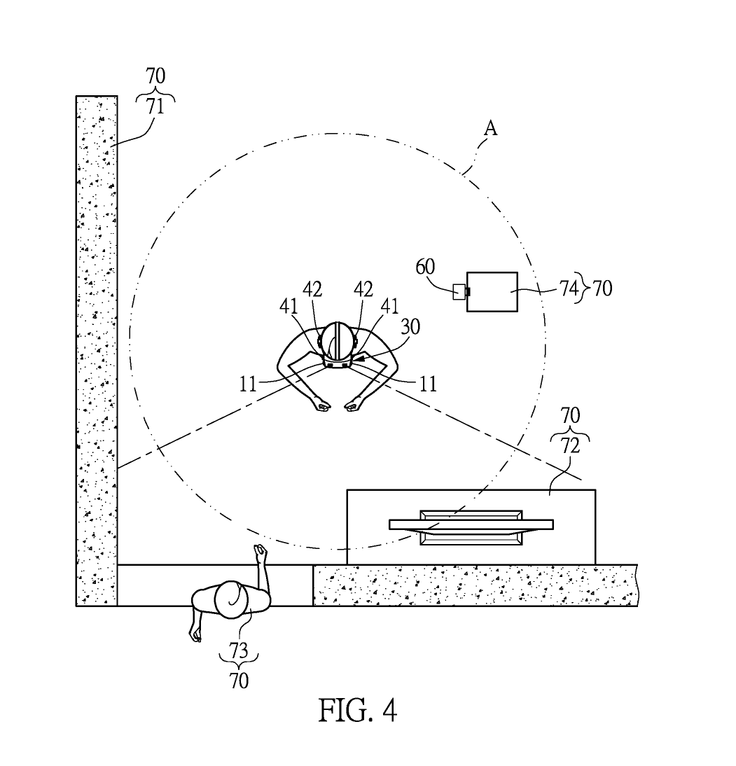

As shown in FIG. 4, the detecting module 10 provided by the present disclosure can detect external objects, such as a wall 71 and stationary objects 72, e.g.: computer, game console, audio system, etc., around the user, and an invader 73 who is approaching the user.

The threat warning system adapted to a virtual reality display device provided by the present disclosure further includes a signaling unit 60 and a receiving unit 61. In the selected embodiment, the signaling unit 60 is disposed with a fastener 62, so that the signaling unit 60 can be fastened on belongings 74 such as a backpack, cellphone, and so on by the fastener 62. The signaling unit 60 continuously sends a positioning signal, and the receiving unit 61 receives the positioning signal. The control module 20 determines a relative distance between the signaling unit 60 and the receiving unit 61 based on the positioning signal sent by the signaling unit 60. When a distance of the signaling unit 60 has been determined to exceed the warning distance, the control module 20 sends a warning signal to the user. As the signaling unit 60 has been fastened on the user's belongings 74, it can prevent the belongings being taken away when the user wears the head-mounted display device 30.

As shown in FIG. 5, the flow chart of a threat warning method adapted to a virtual reality display device of the present disclosure includes the following steps: continuously detecting external objects around a user by the detecting module 10 disposed on the head-mounted display device 30 to obtain distance and direction information about the external objects (S1); outputting the obtained distance and direction information about the external objects to the control module 20 by the detecting module 10 (S2); when the control module 20 has received the distance and direction information about the external objects, determining whether a distance of an external object is smaller than a warning distance (S3); and when the distance of an external object has been determined smaller than the warning distance, the control module 20 producing the threat warning signal through the vibration driving unit 21, the vibration unit 41 of the vibration driving unit 21 and/or the audio unit 42 of the audio driving unit 22 (S4). In S4, the threat warning signal produced by the warning module 40 controlled by the control module 20 is also a direction indicator, so that the user can identify the direction of the external object relative to user according to the threat warning signal.

When the control module 20 has determined that the distance of external object is smaller than the warning distance, the control module 20 further switches the image displayed by the head-mounted display device 30 to the surrounding image signal captured by the image capturing module 50 through the head-mounted display driving module 23 (S5), thereby helping the user to perceive the potential threat through viewing the external surroundings so as to take appropriate measures against the threat.

The receiving unit 61 keeps receiving the positioning signal sent by the signaling unit 60, and the control module 20 determines the relative distance between the signaling unit 60 and the receiving unit 61 based on the positioning signal. When the distance between the signaling unit 60 and the receiving unit 61 has been determined to exceed a predetermined distance, the control module 20 controls the warning module 40 to produce the warning signal (S6) to alert the user that their belongings may be stolen when user wears the head-mounted display device 30.

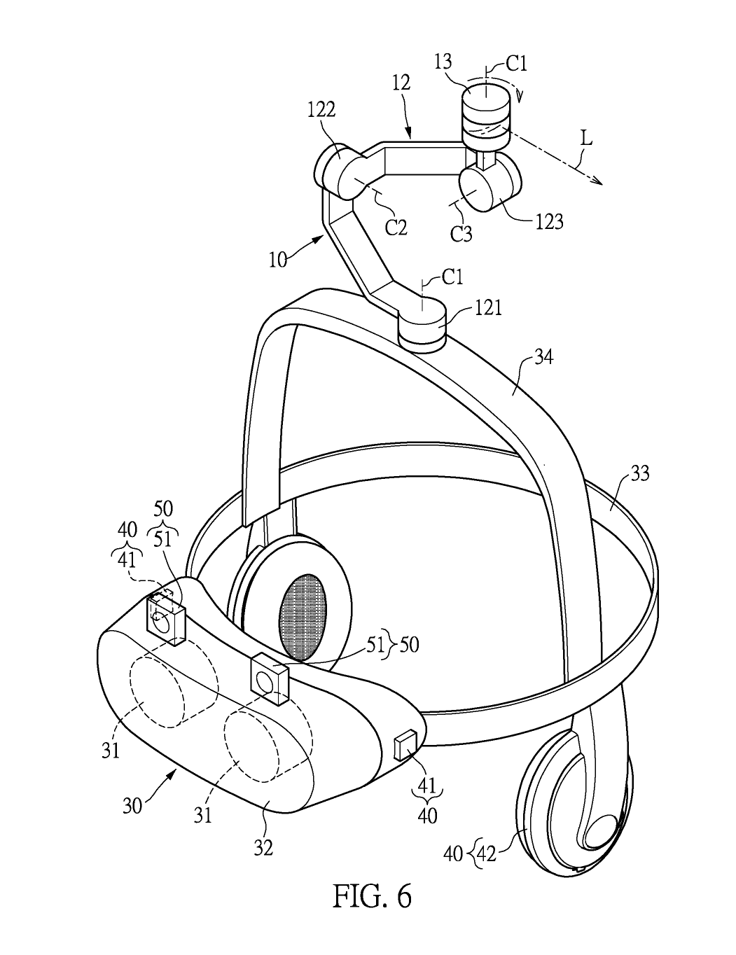

As shown in FIG. 6, in another embodiment of the present disclosure, the head-mounted display device 30 has a frame 34 disposed on the headband 33, and a detecting module 10 disposed on the top of the frame 34, in which the detecting module 10 has a light scanning device 13, and the light scanning device 13 is a LIDAR (light detection and ranging) and able to generate a scanning light L for detecting a distance between at least one external object 70 and the user and a direction of the at least one external object 70. The scanning light rotates around a scanning axil C.

A tri-axils stabilizer 12 is disposed between the light scanning device 13 and the frame 34. The tri-axils stabilizer 12 has a first rotating unit 121, a second rotating unit 122, and a third rotating unit 123. The first rotating unit 121 has a first axil C1 and rotates around the first axil C1; the second rotating unit 122 has a second axil C2 and rotates around the second axil C2; and the third rotating unit 123 has a third axil C3 and rotates around the third axil C3. The first axil C1, the second axil C2 and the third axil C3 are in quadrature with each other.

The tri-axils stabilizer 12 has an angle sensor and a motion sensor integrated therewith for sensing the change of the angle or the motion of the head-mounted display device 30, and adjusting the angle of the light scanning device 13 through the first rotating unit 121, the second rotating unit 122, and the third rotating unit 123 for keeping the scanning axil C perpendicular to ground and stabilizing the light scanning device 13.

In summary, when user wears the head-mounted display device 30 to play virtual reality games or watch virtual reality videos, the head-mounted display device 30 simultaneously detects the distance of external objects such as a wall, game console, screen, and other stationary objects relative to the user. When the distance between the external objects and the user has been determined to be smaller than a predetermined distance, the image capturing module 50 transmits the surrounding image signal to the head-mounted display device 30 to display the direction of the external object, thereby helping the user to perceive the potential threat so as to take appropriate measures against it.

Because the head-mounted display device provided by the present disclosure is capable of simultaneously detecting the distance of external objects such as a wall, game console, screen, and other stationary objects relative to the user while the user wears the head-mounted display device to play virtual reality games or watch virtual reality videos, the shortcomings of the existing HMDs failing to perceive ambient potential threats because the user's eyes are covered can be resolved.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A threat warning system adapted to a virtual reality display device, comprising:
a head-mounted display device;
a headband disposed on the head-mounted display device for wearing on a head of a user;
a frame disposed on the headband;
a detecting module having a light scanning device, the light scanning device disposed on top of the frame, to generate a scanning light that rotates around a scanning axil for detecting a distance between at least one external object and the user and a direction of the at least one external object, and providing distance and direction information;
a tri-axils stabilizer disposed between the light scanning device and the frame for keeping the scanning axil perpendicular to ground;
a warning module producing a threat warning signal; and
a control module electrically connected to the detecting module and the warning module, determining whether a distance between the at least one external object and the user is smaller than a warning distance based on the distance and direction information provided by the detecting module; and when the distance between the at least one external object and the user has been determined to be smaller than the warning distance, the control module controlling the warning module to send the threat warning signal.

2. The threat warning system adapted to a virtual reality display device according to claim 1, wherein the light scanning device is a LIDAR.

3. The threat warning system adapted to a virtual reality display device according to claim 2, wherein the tri-axils stabilizer has a first rotating unit, a second rotating unit, and a third rotating unit; the first rotating unit has a first axil and rotates around the first axil; the second rotating unit has a second axil and rotates around the second axil; the third rotating unit has a third axil and rotates around the third axil; and the first axil, the second axil and the third axil are in quadrature with each other.

4. The threat warning system adapted to a virtual reality display device according to claim 3, wherein the threat warning module comprises a plurality of vibration units which are respectively disposed on the head-mounted display device at different angles, and the control module controls one or more vibration units which correspond to the direction of an external object to produce vibrations so as to produce the threat warning signal which corresponds to the direction of external object.

5. The threat warning system adapted to a virtual reality display device according to claim 4, wherein the threat warning signal comprises an audio signal, the warning module further comprises at least one audio unit, and the audio signal is produced by the at least one audio unit.

6. The threat warning system adapted to a virtual reality display device according to claim 5, wherein the threat warning signal further comprises a visual signal, and the control module drives the head-mounted display device to display the visual signal.

7. The threat warning system adapted to a virtual reality display device according to claim 6, wherein further comprises an image capturing module disposed with at least one image capturing lens, the image capturing module captures the user's surroundings, and the control module determines whether a distance of an external object is smaller than a warning distance; when the distance of the external object has been determined smaller than the warning distance, the control module switches an image source of the head-mounted display device to the surroundings captured by the image capturing module, and then the head-mounted display device is driven to display the surroundings.

8. The threat warning system adapted to a virtual reality display device according to claim 7, wherein further comprises a signaling unit and a receiving unit, wherein the signaling unit is fastened on the user's belongings and sends a positioning signal, the receiving unit is electrically connected to the control module and receives the positioning signal to determine a distance between the signaling unit and the receiving unit; and when the distance between the signaling unit and the receiving unit has been determined to exceed a predetermined distance, the control module controls the warning module to send an warning signal.
